(19) United States
(12) Patent Application Publication
(10) Pub. No.: US 2026/0196783 A1
(43) Pub. Date: Jul. 9, 2026

(54) SHIELDED CONNECTOR, SHIELDED CONNECTOR ASSEMBLY, AND CONNECTOR MANUFACTURING METHOD

(71) Applicant: SUMITOMO WIRING SYSTEMS, LTD., Mie (JP)

(72) Inventors: Takahiro HASEGAWA, Mie (JP); Masato KAMEMURA, Mie (JP)

(21) Appl. No.: 19/440,900

(22) Filed: Jan. 6, 2026

(30) Foreign Application Priority Data
Jan. 9, 2025 (JP) 2025-003455

(51) Int. Cl. H01R 24/22; H01R 13/6581

(52) U.S. Cl. CPC H01R 24/22; H01R 13/6581

(57) ABSTRACT

A shielded connector assembly comprises a shielded connector and a shielded electric wire in which a braid (as an exemplary shielding member) at least partly covers the periphery of an insulator for accommodating a core wire therein, a ring member for fixing the tip of the braid to the insulator, and a shielding body. The shielding body is formed in a cylindrical shape so as to accommodate the shielded electric wire therein, and grounds the braid to a connection counterpart via the ring member when a terminal at the tip of the core wire is electrically connected to the connection counterpart. The shielding body includes a crimped portion fixed to the ring member by crimping, and a deformation restraining portion formed on the crimped portion to restrain deformation of the shielding body when the crimped portion is formed.

### CROSS-REFERENCE TO RELATED APPLICATIONS

This application is based on and claims priority from Japanese Patent Application No. 2025-003455, filed on Jan. 9, 2025, with the Japan Patent Office, the disclosure of which is incorporated herein in its entirety by reference.

### TECHNICAL FIELD

The present invention relates to a shielded connector, a shielded connector assembly and a connector manufacturing method.

### BACKGROUND

Conventionally, an electrical connector for a cable having a shielding braid has been well known as disclosed in Japanese Patent No. 5559213. This electrical connector includes a shielding body to be brought into contact with a shielding braid, a fixing ferrule for fixing the shielding braid and the shielding body to each other by crimping, and a spring washer for bringing the shielding body into contact with an interface of a connection counterpart.

When an electrical connector has a large number of parts, the number of steps for assembling increases, which hinders improvement in productivity. The increased number of parts also increases the cost of the electrical connector. Furthermore, since the shielding body of the electrical connector comes into contact with a connection counterpart, it is also necessary to restrain deformation of the shielding body during assembly in order to ensure sufficient electrical contact between the shielding body and the connection counterpart.

An object of the present disclosure is to provide a shielded connector, a shielded connector assembly and a connector manufacturing method that can achieve both reduction in the number of parts and restraint of deformation of a shielding body.

This object is solved according to the invention by the features of the independent claims. Particular embodiments of the invention are subject of the dependent claims.

### SUMMARY

In order to attain the above object, there is provided a shielded connector to be connected to a shielded electric wire in which a periphery of an insulator is covered with a shielding member, the insulator accommodating at least one core wire herein; the shield connector comprising: a ring member for fixing the shielding member to the insulator; and a shielding body that is formed into such a shape so as to at least partly accommodate the shielded electric wire therein and causes the shielding member to be electrically connected to a mating connector via the ring member when a terminal connected to the core wire is electrically connected to the mating connector, wherein the shielding body includes at least one crimped portion fixed to the ring member by crimping, and at least one deformation restraining portion formed on the crimped portion to restrain deformation of the shielding body when the crimped portion is formed.

According to a specific embodiment, the shielding body substantially is formed in a cylindrical shape so as to at least partly accommodate the shielded electric wire therein.

Particularly, there is provided a shielded connector being connectable with a shielded electric wire in which the periphery of an insulator for accommodating a core wire inside is covered with a braid, a ring member for fixing the tip of the braid to the insulator, and a shielding body that is formed in a cylindrical shape so as to accommodate the shielded electric wire therein and causes the braid to be grounded to a mating connector via the ring member when a terminal at the tip of the core wire is electrically connected to the mating connector, wherein the shielding body includes a crimped portion that is fixed to the ring member by crimping, and a deformation restraining portion formed on the crimped portion to restrain deformation of the shielding body when the crimped portion is formed.

According to another aspect, there is provided a shielded connector assembly of the present disclosure includes a shielded connector and a shielded electric wire in which the periphery of an insulator for accommodating a core wire inside is covered with a braid, a ring member for fixing the tip of the braid to the insulator, and a shielding body that is formed in a cylindrical shape so as to accommodate the shielded electric wire therein and causes the braid to be grounded to a mating connector via the ring member when a terminal at the tip of the core wire is electrically connected to the mating connector, wherein the shielding body includes a crimped portion that is fixed to the ring member by crimping, and a deformation restraining portion formed on the crimped portion to restrain deformation of the shielding body when the crimped portion is formed.

According to the above, the shielding body is or can be crimped onto the shielding member (such as the braid) of the shielded electric wire via the ring member, whereby the shielding body is directly fixed to the shielded electric wire. Therefore, only two parts, which are the ring member and the shielding body, are required to ground or connect the shielding member (such as the braid) to the connection counterpart of the shielded connector, which makes it possible to reduce the number of parts.

Furthermore, since the shielding body is provided with at least one deformation restraining portion for restraining deformation during crimping, even in a structure in which the shielding body is directly fixed to the shielded electric wire by crimping, this portion can absorb deformation of the shielding body, so that it is possible to minimize other deformations.

As a result, it is possible to achieve both reduction in the number of parts and restraint of deformation of the shielding body.

Further particularly, the deformation restraining portion is formed in a shape substantially obtained by folding back a part of the crimped portion.

Accordingly, a method for crimping the shielding body using a blade die having a machined or processed groove of a specified (predetermined or predeterminable) width is or can be used to perform bending forming in which a part of a base material of the shielding body penetrates into the machined or processed groove while bent, thereby forming a deformation restraining portion having a fold-back shape on the shielding body.

Therefore, it is possible to provide the deformation restraining portion on the shielding body by a simple processing method for pressing a blade die having a machined or processed groove of a specified (predetermined or predeterminable) width against the shielding body to crimp the shielding body.

Further particularly, a plurality of the deformation restraining portions are substantially provided in a circumferential direction in the crimped portion.

Accordingly, it is possible to ensure sufficient deformation margin for forming the deformation restraining portions, thereby further contributing to restraint of deformation of the shielding body.

Further particularly, the crimped portion is disposed at the base end of the shielding body, and the shielding body has a connecting portion disposed adjacently to the crimped portion in a direction to the tip of the shielding body.

Accordingly, only the base end of the shielding body is used as a region where the crimped portion is formed.

Therefore, it is possible to use most of the shielding body excluding the crimped portion as the connecting portion, and/or also it is possible to restrain occurrence of deformation in the connecting portion serving as a main portion of the shielding body.

Further particularly, the ring member is formed in a shape having a slit extending in an axial direction of the ring member.

Accordingly, when the shielding body is crimped to the braid via the ring member, the ring member is reduced in diameter together with the shielding body, and is crimped to the shielding member (such as the braid).

Therefore, the ring member can be firmly fixed to the shielding member (such as the braid) together with the shielding body by crimping.

According to another aspect, there is provided a connector assembly comprising a shielded connector according to the above aspect of the invention or a particular embodiment thereof and a shielded electric wire connected or connectable to the shielded connector, wherein in the shielded electric wire a periphery of an insulator at least partly is covered with a shielding member, the insulator accommodating at least one core wire therein.

According to a particular embodiment, the connector assembly further comprises a mating connector connectable to the shielded connector.

According to another aspect of the invention, there is provided a connector assembly manufacturing method for manufacturing a shielded connector assembly including a shielded connector and a shielded electric wire in which a periphery of an insulator at least partly is covered with a shielding member, the insulator accommodating a core wire therein, a ring member for fixing the shielding member to the insulator, and a shielding body that is formed into such a shape so as to at least partly accommodate the shielded electric wire therein, and allows the shielding member to be connected to a mating connector via the ring member when a terminal connected the core wire is electrically connected to the mating connector, the method comprising: providing at least one processing groove to at least one of a plurality of blade dies equipped in a die device; and when the shielding body having the ring member disposed between the shielding body and the shielding member is crimped by the plurality of blade dies to form the crimped portion on the shielding body, releasing a part of the crimped portion into the processing groove, thereby forming the deformation restraining portion for restraining deformation of the shielding body in the crimped portion.

According to a particular embodiment, a connector manufacturing method is a method for manufacturing a shielded connector (assembly) including a shielded electric wire in which the periphery of an insulator for accommodating a core wire inside is covered with a braid, a ring member for fixing the tip of the braid to the insulator, and a shielding body that is formed in a cylindrical shape so as to accommodate the shielded electric wire therein, and causes the braid to be grounded to a mating connector via the ring member when a terminal at the tip of the core wire is electrically connected to the mating connector, the method comprising: providing a machined or processed groove to at least one of a plurality of blade dies equipped in a die device; and when the shielding body having the ring member disposed between the shielding body and the braid is crimped by the plurality of blade dies to form the crimped portion on the shielding body, releasing a part of the crimped portion into the machined or processed groove, thereby forming the deformation restraining portion for restraining deformation of the shielding body in the crimped portion. According to this configuration, the same action and effect as those of the foregoing aspect can be obtained.

Further particularly, one of the blade dies is provided with one or more processing protrusions and the other of the blade dies is provided with one or more processing recesses, wherein the one or more processing protrusions cooperate with the one or more respective processing recesses to form one or more tightly fitted bent portions in the shielding body.

The present disclosure can achieve both reduction in the number of parts and restraint of deformation of the shielding body.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a shielded connector.

FIG. 2 is a perspective view of a terminal assembly of the shielded connector.

FIG. 3 is an exploded perspective view of the terminal assembly of the shielded connector.

FIG. 4 is a perspective view of the terminal assembly of the shielded connector.

FIG. 5 is a perspective view of a ring member.

FIG. 6 is a sectional view taken along line VI-VI in FIG. 2.

FIG. 7 is a perspective view of an outer housing.

FIG. 8 is an exploded perspective view of the outer housing.

FIG. 9 is a schematic diagram of a die device for crimping a shielding body.

FIG. 10 is a schematic diagram of a clamping die for supporting a barrel portion of the shielding body during crimping.

FIG. 11 is a diagram showing the state of the die device when a blade die operation starts.

FIG. 12 is a diagram showing the state of the die device when crimping of the shielding body starts.

FIG. 13 is a diagram showing the state of the die device when crimping has been completed.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Shielded Connector 1

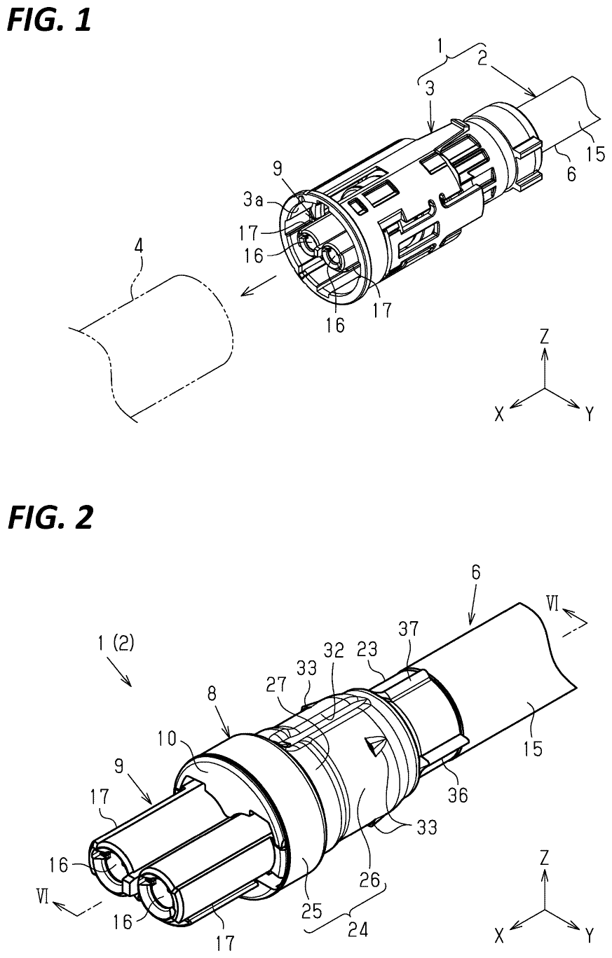

As shown in FIG. 1, the shielded connector 1 includes a terminal assembly 2 having a shielding function to specifically reduce the effects of electrical noise, and an outer housing 3 attached to (particularly the tip of) the terminal assembly 2.

Specifically, the tip of the terminal assembly 2 at least partly is accommodated inside an accommodation portion 3a of the outer housing 3.

A mating connector 4 is connected or connectable to the tip of the shielded connector 1.

The shielded connector 1 is, for example, an in-vehicle connector to be used in a vehicle.

The shielded connector 1 is, for example, a connector to be electrically connected to a vehicle's audio system or car navigation system.

### Terminal Assembly 2

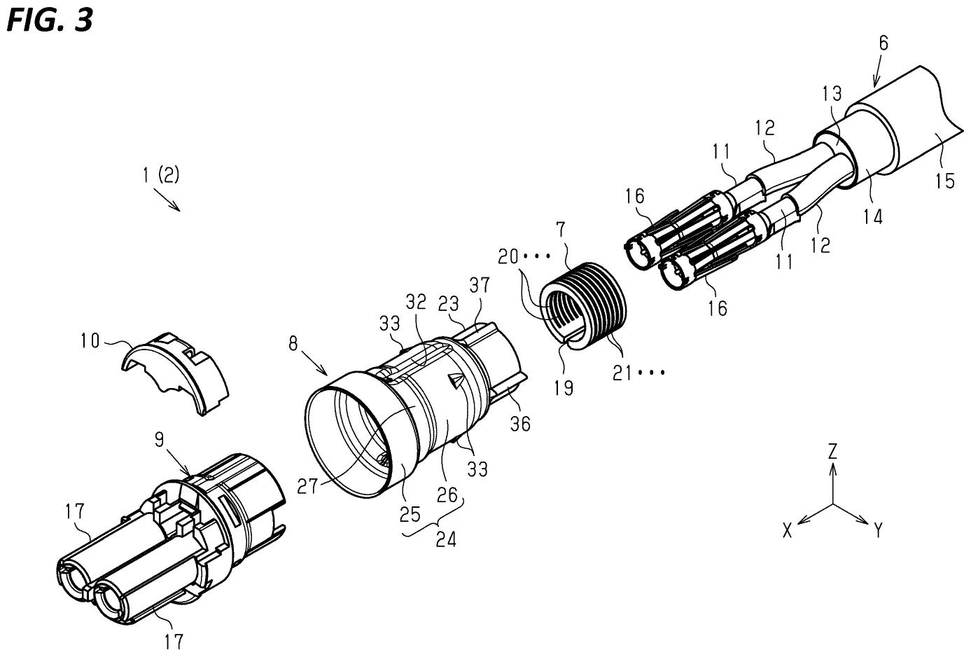

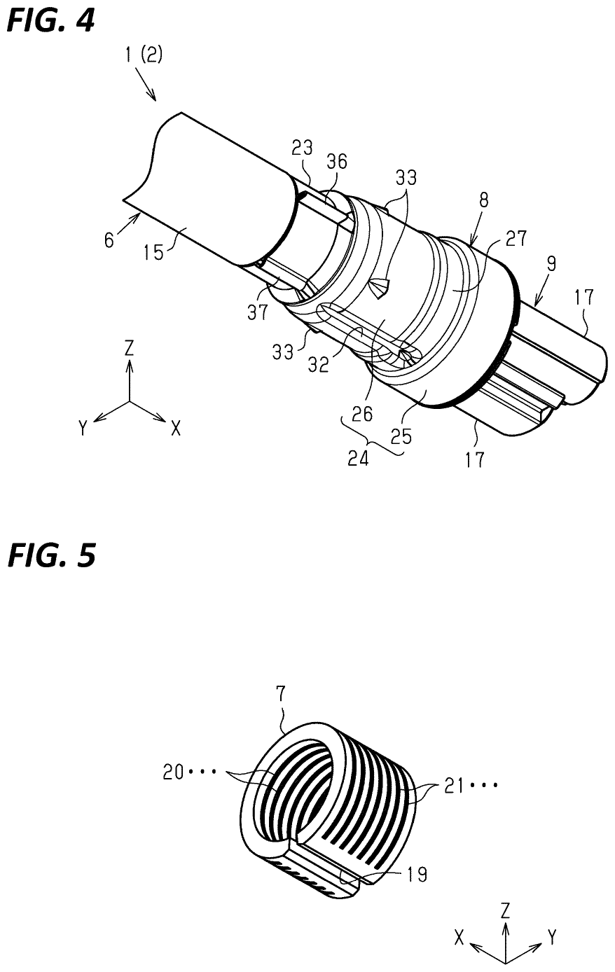

As shown in FIGS. 2 to 4, the terminal assembly 2 specifically includes at least one shielded electric wire 6 that e.g. is protected from electrical noise, a ring member 7 (see FIG. 3) to be fixed to the shielded electric wire 6, and/or a shielding body 8 that grounds the shielded electric wire 6 to the mating connector 4 via the ring member 7 when the shielded connector 1 is connected to the mating connector 4.

Thus, the shielded connector 1 specifically includes the shielded electric wire 6, ring member 7, and/or shielding body 8.

The terminal assembly 2 particularly also includes an inner housing 9 for holding the shielded electric wire 6 inside the shielding body 8, and/or a cover 10 to be attached to (particularly the front surface of) the inner housing 9.

### Shielded Electric Wire 6

As shown in FIG. 3, the shielded electric wire 6 includes one or more core wires 11 through which current flows, one or more insulators 12 for accommodating the core wire(s) 11, an inner jacket 13 that covers the insulators 12, a braid 14 (as a particular shielding member) for shielding the core wire(s) 11 from electromagnetic waves, and/or an outer jacket 15 that at least partly covers the periphery of the braid 14.

Specifically, the core wires 11 are paired to have a positive wire and a negative wire, for example.

The outer peripheral surface of the inner jacket 13 that at least partly accommodates the one or more (particularly paired) core wires 11 is covered with the braid 14.

The braid 14 (as an exemplary shielding member) is, for example, a braid made by weaving metal wires or fibers into a net shape. It is to be understood, that the shielding member may alternatively or additionally comprise a shield layer of conductive material arranged around the one or more core wires 11.

A terminal 16 to be electrically connected to the mating connector 4 is attached and/or fixed to (particularly the tip of) the (particularly each) core wire 11.

The one or more (particularly paired) terminals 16 specifically at least partly are disposed inside one or more terminal receiving holes 17 formed in the inner housing 9, respectively.

### Ring Member 7

As shown in FIGS. 3 and 5, the ring member 7 particularly is formed to have a shape having a slit 19 extending in an axial direction of the ring member 7 (an X-axis direction in FIG. 3, etc.).

The ring member 7 fixes or functions to fix (particularly the tip of) the braid 14 to the insulator 12.

In the case of this example, the ring member 7 has the slit 19. The ring member 7 particularly is temporarily fixed to the braid 14, for example, by being threaded through the braid 14 or by being expanded and assembled with the braid 14.

Subsequently, the ring member 7 particularly is to be shrunk or reduced in diameter by crimping, and fixed to the insulator 12.

Specifically, a plurality of inner grooves 20 are formed in the inner circumferential surface of the ring member 7 and particularly are arranged to be spaced from one another (particularly at substantially equal intervals) in the axial direction of the ring member 7.

One or more, particularly a plurality of outer grooves 21 particularly are formed in the outer circumferential surface of the ring member 7 and particularly are arranged to be spaced from one another (particularly at substantially equal intervals) in the axial direction of the ring member 7.

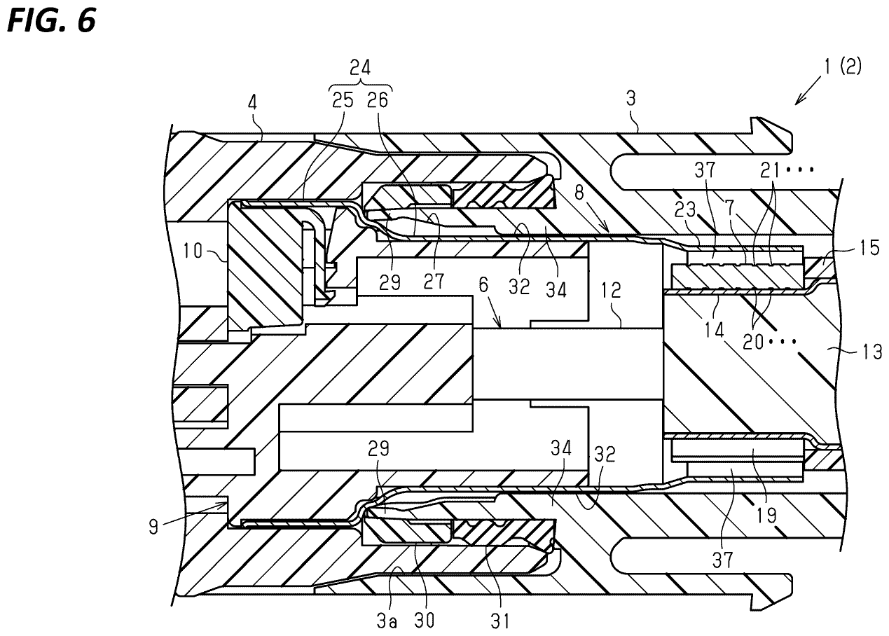

As shown in FIG. 6, the ring member 7 is to be fixed to the outer peripheral surface of (particularly the tip of) the braid 14 by crimping or deformation.

Specifically, the ring member 7 is reduced in diameter by a crimping load such that it at least partly crushes the insulator 12, whereby the ring member 7 is firmly fixed to the outer peripheral surface of the braid 14.

When the ring member 7 is crimped, the one or more, particularly the plurality of inner grooves 20 bite into the braid 14, which causes the ring member 7 to be firmly fixed to the braid 14.

Furthermore particularly, the outer peripheral surface of the ring member 7 at least partly is disposed so as to substantially face the inner peripheral surface of the base end of the shielding body 8.

### Shielding Body 8

As shown in FIGS. 2 to 4, the shielding body 8 (so-called shell) particularly is formed in a substantially cylindrical shape so as to at least partly accommodate the shielded electric wire 6 therein.

When the terminal 16 at (particularly the tip of) the core wire 11 is electrically connected to the mating connector 4, the shielding body 8 grounds the braid 14 (as an exemplary shielding member) to the mating connector 4 via the ring member 7.

The shielding body 8 is made of, for example, conductive material such as metal, and/or is formed in a substantially cylindrical shape.

The shielded electric wire 6 particularly is arranged or arrangeable so as to traverse the inside of the shielding body 8.

Specifically, the shielding body 8 at least partly accommodates the inner housing 9 inside the tip thereof, and/or accommodates the ring member 7 inside the base end thereof.

The shielding body 8 particularly has at least one crimped portion 23 that is crimped or crimpable to the ring member 7 by crimping, deformation or the like.

Specifically, the crimped portion 23 is disposed at the base end of the shielding body 8.

As described above, the base end of the shielding body 8 particularly is to be fixed to the ring member 7 by crimping, deformation or the like, thereby attaching the shielding body 8 to the shielded electric wire 6.

The crimped portion 23 particularly is formed into a substantially annular shape specifically having a smaller diameter than the other portions, for example, by crimping the entire circumference of the base end of the shielding body 8.

The shielding body 8 particularly has at least one connection portion 24 located next to the crimped portion 23 in the direction to the tip of the shielding body 8.

The connection portion 24 particularly corresponds to a non-crimped portion of the shielding body 8.

The connection portion 24 particularly includes at least one shield connection portion 25 that comes or can come into contact with a ground terminal of the mating connector 4, and/or a barrel portion 26 that is a main portion of the shielding body 8.

The shield connection portion 25 and the barrel portion 26 particularly are both formed in a substantially annular shape.

The diameters of the crimped portion 23, the shield connection portion 25, and the barrel portion 26 particularly are set such that the diameter of the crimped portion 23 is smallest, the diameter of the barrel portion 26 is next smallest, and the diameter of the shield connection portion 25 is largest.

The shielding body 8 specifically has at least one opening formed at or near the tip thereof by the shield connection portion 25, and/or at least one opening formed at or near the base end thereof by the crimped portion 23.

The barrel portion 26 particularly is provided with at least one bulge portion 27 that substantially is formed at the boundary between the barrel portion 26 and the shield connection portion 25 such that the bulge portion 27 has a specified (predetermined or predeterminable) larger diameter than the barrel portion 26.

The bulge portion 27 particularly is formed around the substantially entire circumference of the barrel portion 26, and/or is formed in a substantially annular shape.

### Outer Housing 3

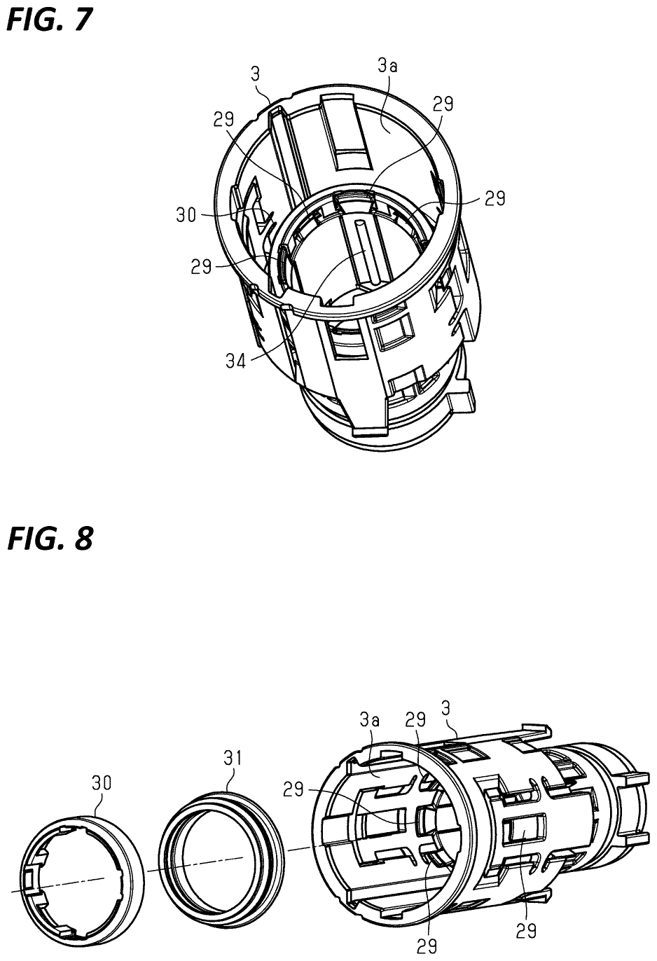

As shown in FIGS. 7 and 8, one or more, particularly a plurality of lances 29 particularly are formed inside the outer housing 3, and specifically support the outer peripheral surface of the shielding body 8 at least partly accommodated in the accommodation portion 3a of the outer housing 3.

Specifically, the one or more lances 29 substantially position the shielding body 8 inside the accommodation portion 3a of the outer housing 3.

The plurality of lances 29 particularly are formed on the inner peripheral surface of the outer housing 3 so as to be arranged in the circumferential direction.

A retainer 30 for restraining the one or more, particularly the plurality of lances 29 from opening and/or a seal member 31 (particularly located behind or adjacent to the retainer 30) are attached to the outer housing 3.

The retainer 30 and/or the seal member 31 particularly are arranged in the gap between the inner peripheral surface of the outer housing 3 and the lances 29.

The seal member 31 includes, for example, an annular rubber or resilient packing.

As shown in FIG. 6, the one or more, particularly the plurality of lances 29 particularly support the shielding body 8 substantially at the position of the bulge portion 27.

The retainer 30 particularly presses, from the outer peripheral side, the one or more, particularly the plurality of lances 29 that has/have been in contact with the bulge portion 27, thereby maintaining a state where the plurality of lances 29 support the barrel portion 26.

The seal member 31 specifically is made to substantially collapse or reduce in diameter when the outer housing 3 and the mating connector 4 are mated with each other, sealing the gap between the outer housing 3 and the mating connector 4.

The seal member 31 particularly restrains fluid from entering the inside of the connector through the gap between the outer housing 3 and the mating connector 4.

### Positioning of Shielding Body 8 with Respect to Outer Housing 3

As shown in FIGS. 2 to 4, one or more positioning recesses 32 for substantially positioning the outer housing 3 and the shielding body 8 particularly are formed on the barrel portion 26 of the shielding body 8.

The one or more positioning recesses 32 specifically are disposed on the outer peripheral surface of the barrel portion 26, and/or particularly are formed in pairs at substantially opposing positions.

One or more, particularly a plurality of protrusions 33 for substantially positioning the shielding body 8 in the axial direction with respect to the outer housing 3 particularly are formed on (particularly the outer peripheral surface of) the barrel portion 26 of the shielding body 8.

Specifically, the plurality of protrusions 33 are arranged circumferentially at specified (predetermined or predeterminable) intervals on the outer peripheral surface of the barrel portion 26.

As shown in FIG. 7, one or more positioning protrusions 34 that substantially engage with the respective one or more positioning recesses 32 of the shielding body 8 particularly are formed on the inner surface of the outer housing 3.

Specifically, two or more positioning protrusions 34 (only one of which is shown in FIG. 7) are formed to correspond to each of the paired positioning recesses 32.

In this way, when the outer housing 3 is fitted, the positioning protrusion(s) 34 of the outer housing 3 particularly engage with the positioning recess(es) 32, thereby setting the position of the shielding body 8 in the circumferential direction.

### Shape of the Crimped Portion 23

As shown in FIGS. 2 to 4, the shielding body 8 particularly has a tightly fitted bent portion 36 formed specifically by bending the base material of the shielding body 8 outward when the crimped portion 23 is formed on the shielding body 8.

The tightly fitted bent portion 36 particularly is a deformation portion that occurs unavoidably in the crimped portion 23, for example, when the crimped portion 23 is formed on the shielding body 8 by die molding.

A plurality of tightly fitted bent portions 36 may be formed, and in this example, a pair of tightly fitted bent portions 36 are formed so as to substantially face each other.

In the case of this example, the paired tightly fitted bent portions 36 particularly substantially are located at one position in a left-right direction (the “3 o'clock” position on a clock) and the other position in the left-right direction (the “9 o'clock” position on a clock) respectively when the shielding body 8 is viewed in the axial direction.

The shielding body 8 particularly has at least one deformation restraining portion 37 that is formed in or at the crimped portion 23 to substantially restrain deformation of the shielding body 8 when the crimped portion 23 is formed.

The deformation restraining portion 37 particularly is formed in or at the crimped portion 23 as a relief portion for a deformation amount that cannot be tolerated by the tightly fitted bent portion 36 alone when the shielding body 8 is crimped.

The deformation restraining portion 37 specifically is formed in a shape obtained by folding back a part of the crimped portion 23.

Further specifically, a plurality of deformation restraining portions 37 (two in this example) are provided in the circumferential direction on the crimped portion 23. Specifically, the deformation restraining portions 37 substantially are provided at the top position (the “0 o'clock” position on a clock) and the bottom position (the “6 o'clock” position on a clock) when the shielding body 8 is viewed in the axial direction.

### Die Device 39

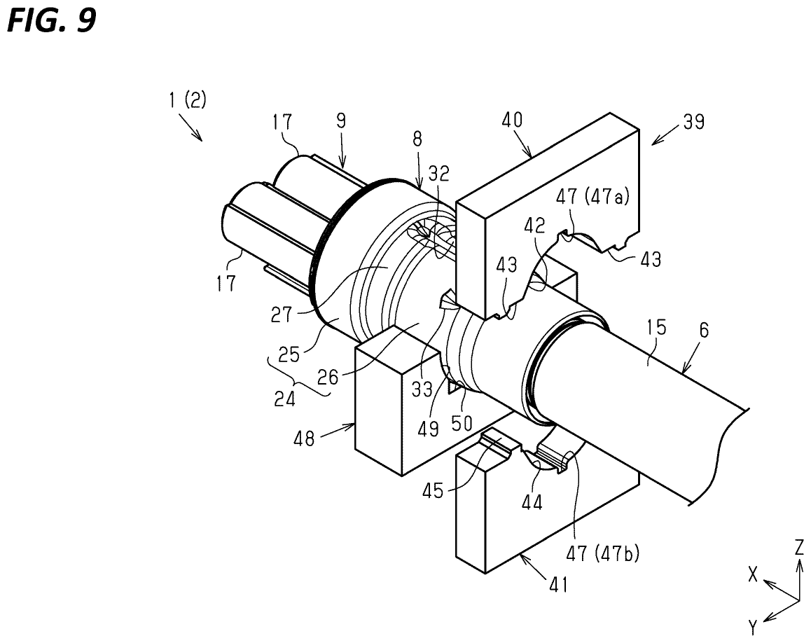

As shown in FIG. 9, the deformation restraining portion 37 of the shielding body 8 particularly is manufactured using a die device 39.

The die device 39 specifically has a first blade die 40 and a second blade die 41 that pinch or embraces or squeezes the crimped portion 23 substantially from substantially both sides and/or deform the crimped portion 23 to form the one or more deformation restraining portions 37.

The first blade die 40 particularly has a processing surface 42 for applying a deformation load to one surface or part of the outer peripheral surface of the base end of the shielding body 8.

For example, starting from an initial position radially outward (e.g. substantially above) the shielding body 8, the first blade die 40 substantially moves linearly toward and away from the shielding body 8.

The first blade die 40 is provided with one or more concave processing recesses 43 that are formed at (particularly both ends of) the processing surface 42 and/or cooperate with the second blade die 41 to form the tightly fitted bent portions 36 in the shielding body 8.

The second blade die 41 particularly has a processing surface 44 for substantially applying a deformation load to the other surface of the outer peripheral surface of (particularly the base end of) the shielding body 8.

For example, starting from an initial position radially outward e.g. substantially below the shielding body 8, the second blade die 41 substantially moves linearly toward and away from the shielding body 8.

The second blade die 41 particularly is provided with one or more processing protrusions 45 that are formed at (particularly both ends of) the processing surface 44 and/or substantially cooperate with the one or more respective processing recesses 43 of the first blade die 40 to form the tightly fitted bent portions 36 in the shielding body 8.

A part of (particularly the base end of) the shielding body 8 particularly is clamped, bent and/or deformed by the processing recess(es) 43 and/or the processing protrusion(s) 45, thereby forming the tightly fitted bent portion(s) 36 in the shielding body 8.

Specifically, at least one of the first blade die 40 and the second blade die 41 has at least one processing groove 47 formed therein. The processing groove 47 particularly forms the deformation restraining portion 37 in the shielding body 8 in the processing of crimping the shielding body 8 to crimp the shielding body 8 to the ring member 7.

In the case of this example, the processing groove 47 is formed in each of the first blade die 40 and the second blade die 41.

Specifically, the first blade die 40 has at least one first processing groove 47a as the processing groove 47 particularly substantially at the top of the processing surface 42.

The second blade die 41 particularly has at least one second processing groove 47b as the processing groove 47 particularly substantially at the bottom of the processing surface 44.

The processing groove 47 particularly is formed, for example, in a slit-like shape substantially extending in a thickness direction of the blade die (the X-axis direction in FIG. 9).

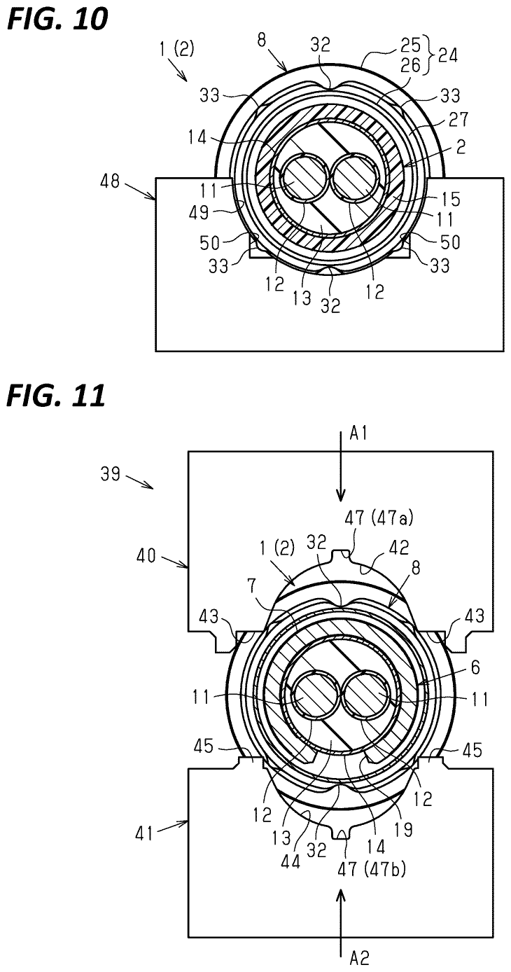

As shown in FIGS. 9 and 10, the die device 39 particularly has at least one clamping die 48 for clamping the outer peripheral surface of the connection portion 24 of the shielding body 8 substantially when the crimped portion 23 is formed.

The clamping die 48 particularly has at least one support surface 49 for supporting the connection portion 24 of the shielding body 8 during crimping.

In this example, the support surface 49 is formed in a substantially arc shape along half of the outer periphery of the barrel portion 26 of the shielding body 8.

One or more recessed portions 50 particularly are formed in or at the support surface 49 and provide relief layout for the one or more protrusions 33 formed on the barrel portion 26.

The clamping die 48 particularly substantially supports a lower part (e.g. substantially the lower half) of the barrel portion 26 from the periphery when crimping the shielding body 8, thereby particularly substantially restraining the connection portion 24 of the shielding body 8 from deforming outward in a radial direction.

### Action of Embodiment

Next, an action or operation of the shielded connector 1 and a connector manufacturing method of the present embodiment will be described.

### Method for Manufacturing Crimped Portion 23

As shown in FIG. 9, the terminal assembly 2 to which the (particularly pre-crimped) shielding body 8 is attached substantially is set in the die device 39.

The pre-crimped shielding body 8 particularly has a substantially cylindrical shape in which the base end thereof at which the crimped portion 23 will be formed particularly substantially has a diameter roughly equal to that of the barrel portion 26.

Specifically, the (particularly pre-crimped) ring member 7 is disposed substantially inside the base end of the (particularly pre-crimped) shielding body 8.

The barrel portion 26 of the shielding body 8 substantially is placed on the support surface 49 of the clamping die 48, and/or (particularly the base end of) the shielding body 8 substantially is placed between the first blade die 40 and the second blade die 41.

As shown in FIG. 11, after the terminal assembly 2 is set in the die device 39, the first blade die 40 and the second blade die 41 start to move substantially toward each other.

In the case of this example, the first blade die 40 starts to slide downward (in a direction of arrow A1 in FIG. 11), while the second blade die 41 starts to slide upward (in a direction of arrow A2 in FIG. 11).

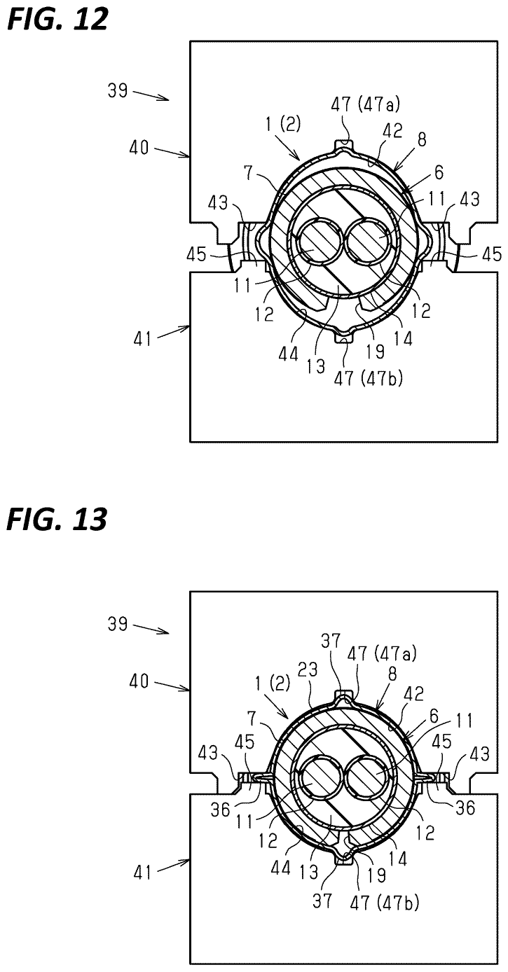

As shown in FIG. 12, when the first blade die 40 and the second blade die 41 both reach the base end of the shielding body 8 and continue to further move, the base end of the shielding body 8 particularly substantially is crushed (particularly substantially from all sides) by the first blade die 40 and the second blade die 41.

In other words, the base end of the shielding body 8 starts to be crimped or deformed to the ring member 7 and the shielded electric wire 6 by the crimping of the first blade die 40 and the second blade die 41.

When a crimping load specifically is applied to (particularly the base end of) the shielding body 8 by the first blade die 40 and the second blade die 41, both portions (particularly ends of the base end) of the shielding body 8 in the lateral or left-right direction in the shown example are pinched between the processing recesses 43 of the first blade die 40 and the processing protrusions 45 of the second blade die 41, whereby both the portions (particularly the ends of the base end) of the shielding body 8 are caused to deform and bend outward.

As a result, formation of the tightly fitted bent portions 36 particularly starts at both ends of the base end of the shielding body 8 in the lateral or left-right direction on the page.

This causes the base end of the shielding body 8 to be crimped to the braid 14 (as an exemplar shileding member) via the ring member 7.

Furthermore, the ring member 7 particularly is crimped together with the shielding body 8 by a load from the first blade die 40 and the second blade die 41, and is crimped or deformed to the insulator 12.

Furthermore, a part of the base end of the shielding body 8 specifically substantially deforms so as to at least partly relieve into the first processing groove 47a of the first blade die 40 and/or the second processing groove 47b of the second blade die 41.

Specifically, the top of the base end of the shielding body 8 at least partly enters the first processing groove 47a of the first blade die 40 while bending and deforming, and/or the bottom of the base end of the shielding body 8 at least partly enters the second processing groove 47b of the second blade die 41 while bending and deforming.

As a result, the one or more deformation restraining portions 37 are formed on (particularly substantially both the top and bottom of the base end of) the shielding body 8.

As shown in FIG. 13, when each of the first blade die 40 and the second blade die 41 moves to its end, the processing recesses 43 of the first blade die 40 and the processing protrusion 45 of the second blade die 41 significantly crush (particularly both the lateral or left and right ends of) the shielding body 8, thereby forming the one or more (particularly paired) tightly fitted bent portions 36.

Furthermore, the top of the shielding body 8 particularly substantially fully fits into the first processing groove 47a of the first blade die 40, and/or the bottom of the shielding body 8 particularly substantially fully fits into the second processing groove 47b of the second blade die 41, thereby forming the one or more (particularly paired) deformation restraining portions 37 in the shielding body 8.

When the first blade die 40 and the second blade die 41 crimp (particularly the base end of) the shielding body 8, they specifically also crimp the ring member 7 together with the shielding body 8.

As described above, (particularly the base end of) the shielding body 8 is crimped to the outer circumferential surface of the braid 14 of the shielded electric wire 6 via the ring member 7 by the crimping of the first blade die 40 and the second blade die 41.

In this way, the crimped portion 23 for fixing the shielding body 8 to the shielded electric wire 6 particularly is formed at (particularly the base end of) the shielding body 8.

### Advantages of Shielded Connector 1 of Present Example

As shown in FIG. 6, in the shielded connector 1 of the present example, the shielding body 8 particularly is directly fixed to the ring member 7 for fixing the braid 14 (as an exemplary shielding member) of the shielded electric wire 6.

Therefore, particularly only two parts which are the shielding body 8 and the ring member 7 are required to ground the braid 14 to the mating connector 4. This reduces the number of parts required to ground the braid 14 to the mating connector 4, thereby reducing the number of parts required for the shielded connector 1.

As shown in FIG. 2, etc., the one or more deformation restraining portions 37 for releasing the deformation load applied to the shielding body 8 during crimping particularly are formed on the crimped portion 23 of the shielding body 8.

This specifically restrains the deformation load occurring in the shielding body 8 substantially from reaching the connection portion 24, specifically the shield connection portion 25 of the shielding body 8 when the shielding body 8 is fixed to the ring member 7 by crimping, so that it particularly is possible to substantially restrain occurrence of excessive deformation of the connection portion 24 (specifically, the shield connection portion 25) of the shielding body 8.

This advantageously ensures good electrical contact between the shield connection portion 25 of the shielding body 8 and the mating connector 4 when the shielded connector 1 is mated with the mating connector 4.

This particularly also contributes to smooth mating between the mating connector 4 and the shield connection portion 25.

Furthermore, when the shielding body 8 is crimped, the barrel portion 26 of the shielding body 8 particularly is supported by the clamping die 48, which particularly substantially restrains opening deformation of the barrel portion 26.

When the opening deformation of the barrel portion 26 particularly is restrained as described above, the deformation of the shield connection portion 25 of the shielding body 8 particularly is also restrained.

Therefore, from this perspective as well, it can be said that it is very effective to support the barrel portion 26 of the shielding body 8 using the clamping die 48.

### Effects of Embodiment

The shielded connector 1 and the connector manufacturing method according to the above embodiment achieve the following effects.
(1) The shielded connector 1 particularly includes the shielded electric wire 6 in which the braid 14 at least partly covers (particularly the peripheries of) the insulator(s) 12 (particularly each) accommodating the core wire 11 therein, the ring member 7 for fixing (particularly the tip of) the braid 14 to the insulator(s) 12, and the shielding body 8.

The shielding body 8 particularly substantially is formed in a cylindrical shape so as to at least partly accommodate the shielded electric wire 6 therein, and grounds or electrically connects the braid 14 to the mating connector 4 via the ring member 7 when the terminal(s) 16 at the tip(s) of the core wire(s) 11 is/are electrically connected to the mating connector 4.

The shielding body 8 particularly includes the crimped portion 23 fixed or fixable to the ring member 7 by crimping, and/or the one or more deformation restraining portions 37 formed on the crimped portion 23 to restrain deformation of the shielding body 8 particularly when the crimped portion 23 is formed.

According to this configuration, the shielding body 8 particularly is crimped to the braid 14 of the shielded electric wire 6 via the ring member 7, thereby directly fixing the shielding body 8 to the shielded electric wire 6.

Therefore, specifically only two parts which are the ring member 7 and the shielding body 8 are required to ground or electrically connect the braid 14 to the connection counterpart of the shielded connector 1, so that it is possible to reduce the number of parts.

Furthermore, the shielding body 8 particularly is provided with the at least one deformation restraining portion 37 for restraining deformation during crimping.

Therefore, even in a structure in which the shielding body 8 is directly fixed to the shielded electric wire 6 by crimping, deformation of the shielding body 8 (specifically, the tip of the shielding body 8) particularly can be absorbed by the deformation restraining portion(s) 37, so that it is possible to minimize other deformation.

As a result, it particularly is possible to achieve both reduction in the number of parts and restraint of deformation of the shielding body 8.
(2) The deformation restraining portion 37 particularly substantially is formed in a shape obtained by folding back a part of the crimped portion 23.

According to this configuration, a method for crimping the shielding body 8 using blade dies (in this example, the first blade die 40 and the second blade die 41) having the one or more processing grooves 47 of a specified (predetermined or predeterminable) width particularly is or can be used to perform bending forming in which a part of the base material of the shielding body 8 at least partly penetrates into the one or more processing grooves 47 while bent, whereby the one or more deformation restraining portions 37 (particularly each) substantially having a fold-back shape is formed on the shielding body 8.

Therefore, it particularly is possible to provide the one or more deformation restraining portions 37 on the shielding body 8 by a simple processing method for pressing the blade dies (in this example, the first blade die 40 and the second blade die 41) having the one or more processing grooves 47 of a specified (predetermined or predeterminable) width against the shielding body 8 to crimp the shielding body 8.
(3) The plurality of the deformation restraining portions 37 particularly are provided in the circumferential direction in the crimped portion 23.

According to this configuration, it particularly is possible to ensure sufficient deformation margin for forming the deformation restraining portion(s) 37, thereby further contributing to restraint of deformation of the shielding body 8.
(4) The crimped portion 23 particularly is disposed at or near the base end of the shielding body 8, and/or the shielding body 8 particularly has the connecting portion 24 disposed adjacently to the crimped portion 23 in a direction to the tip of the shielding body 8.

According to this configuration, only the base end of the shielding body 8 particularly is used as a region where the crimped portion 23 is formed.

Therefore, it particularly is possible to use most of the shielding body 8 excluding the crimped portion 23 as the connecting portion 24, and/or also it particularly is possible to restrain occurrence of deformation in the connecting portion 24 serving as a main portion of the shielding body 8.
(5) The ring member 7 particularly is formed in a shape having at least one slit 19 substantially extending in an axial direction of the ring member 7.

According to this configuration, when the shielding body 8 particularly is crimped to the braid 14 via the ring member 7, the ring member 7 is or can be reduced in diameter together with the shielding body 8, and is crimped or connected to the braid 14.

Therefore, the ring member 7 can be firmly fixed to the braid 14 together with the shielding body 8 by crimping.

Accordingly, a shielded connector, a shielded connector assembly and a connector manufacturing method that can achieve both reduction in the number of parts and restraint of deformation of a shielding body are provided. A shielded connector assembly comprises a shielded connector 1 and a shielded electric wire 6 in which a braid 14 (as an exemplary shielding member) at least partly covers the periphery of an insulator 12 for accommodating a core wire 11 therein, a ring member 7 for fixing the tip of the braid 14 to the insulator 12, and a shielding body 8. The shielding body 8 substantially is formed in a cylindrical shape so as to at least partly accommodate the shielded electric wire 6 therein, and grounds the braid 14 to a connection counterpart via the ring member 7 when a terminal 16 at the tip of the core wire 11 is electrically connected to the connection counterpart. The shielding body 8 includes a crimped portion 23 fixed to the ring member 7 by crimping, and a deformation restraining portion 37 formed on the crimped portion 23 to restrain deformation of the shielding body 8 when the crimped portion 23 is formed.

### Other Embodiments

The present embodiment can be modified as follows. The present embodiment and the following modifications can be combined with each other to the extent that no technical contradictions exist.

The processing surface 44 of each of the first blade die 40 and the second blade die 41 is not limited to a shape that approximately profiles a semicircle of a perfect circle.

For example, the processing surface 44 may be a shape that approximately profiles a semicircle obtained e.g. by bisecting an ellipse flattened toward the processing groove 47 at the center in a flattening direction.

The shapes of the one or more processing grooves 47 of the first blade die 40 and/or the second blade die 41 may be changed to other shapes substantially according to the required shape of the deformation restraining portion 37.

The processing groove 47 may be formed in only one of the first blade die 40 and the second blade die 41.

The number of the blade dies of the die device 39 is not limited to two, the first blade die 40 and the second blade die 41, and it may be changed to another number such as four, six or more.

The shape of the deformation restraining portion 37 is not limited to a shape that substantially protrudes outward in the radial direction of the shielding body 8, and may be, for example, a shape that substantially protrudes inward in the radial direction of the shielding body 8.

In this case, the deformation restraining portion 37 may be disposed inside the slit 19 of the ring member 7.

The number of the deformation restraining portions 37 is not limited to a plural number, and may be only one.

The crimped portion 23 may have a shape obtained by omitting the tightly fitted bent portion 36.

The crimped portion 23 does not have to be formed at the base end of the shielding body 8, and may be formed at a position other than the position of the base end.

The shield connection portion 25 particularly may have at least one spring portion that makes electrical contact with the connection counterpart by elastic deformation.

The ring member 7 does not necessarily have to be attached to the outer peripheral surface of the tip of the braid 14.

For example, the tip of the braid 14 may be substantially formed in a fold-back shape, and/or the ring member 7 may be placed substantially inside the fold-back portion.

The number of pairs of the core wires 11 and the insulators 12 is not limited to a plural number, and may be only one.

The expression “at least one” used in this disclosure means “one or more” of the desired options. As one example, the expression “at least one” used in this disclosure means “only one option” or “both of two options” if the number of options is two. As another example, the expression “at least one” used in this disclosure means “only one option” or “any combination of two or more options” if the number of options is three or more.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A shielded connector to be connected to a shielded electric wire in which a periphery of an insulator is covered with a shielding member, the insulator accommodating at least one core wire therein; the shield connector comprising:
a ring member for fixing the shielding member to the insulator; and
a shielding body that is formed into such a shape so as to at least partly accommodate the shielded electric wire therein and causes the shielding member to be electrically connected to a mating connector via the ring member when a terminal connected to the core wire is electrically connected to the mating connector, wherein
the shielding body includes at least one crimped portion fixed to the ring member by crimping, and at least one deformation restraining portion formed on the crimped portion to restrain deformation of the shielding body when the crimped portion is formed.

2. The shielded connector according to claim 1, wherein the shielding body substantially is formed in a cylindrical shape so as to at least partly accommodate the shielded electric wire therein.

3. The shielded connector according to claim 1, wherein the deformation restraining portion is formed in a shape substantially obtained by folding back a part of the crimped portion.

4. The shielded connector according to claim 1, wherein the at least one deformation restraining portion includes a plurality of deformation restraining portions substantially provided in a circumferential direction in the crimped portion.

5. The shielded connector according to claim 1, wherein the crimped portion is disposed at a base end of the shielding body, and the shielding body has a connecting portion disposed adjacently to the crimped portion in a direction to the tip of the shielding body.

6. The shielded connector according to claim 1, wherein the ring member is formed in a shape having a slit extending in an axial direction of the ring member.

7. A connector assembly comprising a shielded connector according to claim 1 and a shielded electric wire connected to the shielded connector, wherein in the shielded electric wire a periphery of an insulator is covered with a shielding member, the insulator accommodating at least one core wire therein.

8. The connector assembly according to claim 7, further comprising a mating connector connectable to the shielded connector.

9. A connector assembly manufacturing method for manufacturing a shielded connector assembly including a shielded connector and a shielded electric wire in which a periphery of an insulator is covered with a shielding member, the insulator accommodating a core wire therein, a ring member for fixing the shielding member to the insulator, and a shielding body that is formed into such a shape so as to at least partly accommodate the shielded electric wire therein, and allows the shielding member to be connected to a mating connector via the ring member when a terminal connected the core wire is electrically connected to the mating connector, the method comprising:
providing at least one processing groove to at least one of a plurality of blade dies equipped in a die device; and
when the shielding body having the ring member disposed between the shielding body and the shielding member is crimped by the plurality of blade dies to form the crimped portion on the shielding body, releasing a part of the crimped portion into the processing groove, thereby forming the deformation restraining portion for restraining deformation of the shielding body in the crimped portion.

10. The connector assembly manufacturing method according to claim 9, wherein one of the blade dies is provided with one or more processing protrusions and the other of the blade dies is provided with one or more processing recesses, wherein the one or more processing protrusions cooperate with the one or more respective processing recesses to form one or more tightly fitted bent portions in the shielding body.
